(19) United States
(12) Patent Application Publication
(10) Pub. No.: US 2016/0224123 A1
(43) Pub. Date: Aug. 4, 2016

(54) METHOD AND SYSTEM TO CONTROL ELECTRONIC DEVICES THROUGH GESTURES

(71) Applicant: Augumenta Ltd, Oulu (FI)

(72) Inventors: Peter M Antoniac, Oulu (FI); Tero Aaltonen, Taipei (TW); Damien Douxchamps, Kyoto (JP); Harri Kovalainen, Oulu (FI)

(21) Appl. No.: 15/013,021

(22) Filed: Feb. 2, 2016

Related U.S. Application Data
(60) Provisional application No. 62/110,800, filed on Feb. 2, 2015.

(51) Int. Cl. G06F 3/01; G06T 19/00

(52) U.S. Cl. CPC G06F 3/017; G06T 19/006

(57) ABSTRACT

The present disclosure provides a method for controlling a computing device through hand gestures, using augmented reality. The method includes detecting a toggle gesture. The method further includes analyzing the toggle gesture. The method further includes switching a first interface of the computing device to a second interface based on the analysis of the toggle gesture.

### REFERENCE TO RELATED APPLICATION

The present application claims priority benefit under 35 U.S.C. §119(e) from a U.S. Provisional Application No. 62/110,800, filed 2 Feb. 2015, entitled “METHOD AND SYSTEM TO CONTROL ELECTRONIC DEVICES THROUGH PRE-DETERMINED GESTURES UTILIZING AUGMENTED REALITY,” which is incorporated herein by reference.

### TECHNICAL FIELD

The present invention relates to the field of gesture based technologies and, in particular, relates to controlling devices through one or more gestures.

### BACKGROUND

In past few decades, there has been a drastic change in the field of communication devices and technology associated with them. For example, the earlier communication devices which were prevalent were wired telephones, telegrams, pagers and the like. However, nowadays, most of the people use mobile devices, personal computers, laptops, smart phones, smart glasses, head-mounted displays, near-eye displays and the like. The term “smart glass” generally refers to a head-mounted device that includes a display and sometimes can take the form of an eye glass, but also it can be a helmet that contains with a display to cover the eyes. Some smart glasses include computing unit and a camera or other sensing device that is pointing away from a user's face. Such hardware can be used for analyzing images captured by the camera or the sensed data and present information to the user

Usually such devices are wearable by the user and hence they may not be mobile. In addition, these devices require a power source such as, a battery or accumulator. A display of such devices usually consumes a lot of electric energy.

The gesture recognition may allow humans to communicate with machines and interact with them naturally by using a series of algorithms. The gesture recognition technology can be hand gesture recognition, facial gesture recognition, sign language recognition and the like. The hand gestures can be a natural way for communicating, and in fact some of the information can be passed via hand signs in a faster and simpler way as compared to any other way. For example, major auction houses use the hand gestures for bidding on multi-million auctions. Further, the hand gesture recognition technology may allow operations of complex machines by using only a series of fingers and hand movements, and may eliminate the need for physical contact between operator and the machine. Moreover, using a concept of the gesture recognition, it is now possible to point the finger at a computer screen to move cursor accordingly. For example, military air marshals use hand and body gestures to direct flight operations aboard aircraft carriers.

Currently, there are few systems that use stereo-vision combined with infrared light to control and/or interact with communication devices. Other conventional hand gesture recognition systems include Time-of-Flight (ToF) cameras, the use of textured light, and other depth or proximity sensing devices. Although, these systems provide powerful recognition but they use extra energy and are more expensive.

Moreover, some systems use special sensors which are worn by a user for capturing movements, and translate it into commands. These systems are complex to set up and expensive in terms of cost of materials as well as energy consumed. Furthermore, there are some systems that use motion vectors in video image and base separation on detected vectors. However, these systems fail when the user wears the camera on his/her body while the head or the body is moving causing the false detection of motion by the system. In addition, most of the above stated systems do not efficiently incorporate environmental variations including exposure, lighting, background color, back-light, different user hands, skin color, wearing of gloves and the like while controlling these communication devices.

In light of the above stated discussion, there is a need for a method and system that overcomes the above stated disadvantages. Moreover, the method and system should be robust and read the motion of the user hands optimally.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are various embodiments of the present disclosure providing methods, systems, and computer program products for controlling a computing device through a number of gestures, primarily hand gestures. The present disclosure further provides systems and methods for improved techniques for controlling a computing device by using a series of hand gestures.

The present disclosure finds particular application in controlling one or more settings/features/functions of a computing device or of electronic device(s) through various gestures, and will be described with particular reference thereto. However, it is to be appreciated that the present disclosure is also amenable to other similar applications.

In an aspect of the present disclosure, a method for controlling a computing device through hand gestures is disclosed. The method includes detecting a toggle gesture. The method further includes analyzing the toggle gesture. The method further includes switching a first interface of the computing device to a second interface based on the analysis of the toggle gesture.

In an embodiment, the toggle gesture is compared with a number of pre-defined gestures.

In another embodiment, a display associated with the computing device is activated based on a detection of a start gesture.

In further embodiment, the display associated with the computing device is activated based on a detection of an end gesture.

In some embodiments, the pre-defined gestures are defined by a user.

In another aspect of the present disclosure, a system for controlling a computing device through a number of hand gestures is provided. The system includes a database configured to store a number of pre-defined gestures, a number of pre-defined control commands, a number of pre-defined actions, a toggle gesture, a start gesture, an end gesture, a number of modes of operation, and so forth. The system includes a detection module configured to detect a toggle gesture. The system further includes an analyzing module configured to analyze the detected toggle gesture; and compare the detected toggle gesture with a number of pre-defined gestures. The system furthermore includes a controlling module configured to switch a first interface of the computing device to a second interface based on the analysis.

In one embodiment, the detection module detects the start gesture and the end gesture.

In another embodiment, the controlling module activates a display of the computing device when the start gesture is detected.

In further embodiment, the controlling module de-activates the display of the computing device when the end user is detected.

In some embodiments, the pre-defined gestures ate defined by a user.

In one embodiment, the first interface and the second interface are displayed on a computer graphics overlay.

In another aspect, the present disclosure provides a method for controlling a computing device through a number of hand gestures. The method includes detecting a toggle gesture and activating a display of the computing device based on the detection of the toggle gesture. The method further includes displaying a computer graphics overlay on the display. A hand of a user is mapped onto the computer graphics overlay. The method also includes controlling a movement of a cursor on the computer graphics overlay based on one or more hand gestures of the user.

In one embodiment, spatial data is captured based on a movement of the hand in a viewable area of the computing device.

In another embodiment, at least one of a 2 dimensional and a 3 dimensional data map is produced based on the spatial data.

In an embodiment, one or more pre-defined hand gestures are determined based on the one or more hand gestures.

In a yet another embodiment, a pre-defined action is determined corresponding to the at least one of the 2 dimensional and a 3 dimensional data map and the pre-defined action is executed.

In another embodiment, one or more pre-defined control commands corresponding to the one or more pre-defined hand gestures are determined and the one or more pre-defined hand gestures are executed

In another embodiment, a cursor position displayed on the computer graphics overlay is calculated as a function of a size of the hand and a position of at least one of the hand or fingers of the hand.

In yet another embodiment, the display of the computing device is de-activated when an end gesture is detected.

In another aspect of the present disclosure, a system for controlling a computing device through a plurality of gestures is provided. The system includes a detection module for detecting a toggle gesture. The system also includes a display module for activating a display of the computing device based on the detection of the toggle gesture; and displaying a computer graphics overlay on the display, wherein a hand of a user is mapped onto the computer graphics overlay. The system also includes a controlling module for controlling a movement of a cursor on the computer graphics overlay based on one or more hand gestures of the user.

In an embodiment, the system includes an image capturing module including one or more sensors for capturing spatial data based on a movement of the hand in a viewable area of the computing device.

In another embodiment, the system further includes an analyzing module for producing at least one of a two dimensional data map and a three dimensional data map; and determining at least one pre-defined action corresponding to the at least one of the 2 dimensional and the 3 dimensional data map.

In another embodiment, the controlling module is configured to execute the at least one pre-defined action.

In an embodiment, the analyzing module is further configured to determine one or more pre-defined hand gestures based on the detected hand gestures; and determine one or more pre-defined control commands corresponding to the one or more pre-defined hand gestures,

In an embodiment, the controlling module is configured to execute the one or more pre-defined control commands.

In another embodiment, the controlling module is configured to calculate a cursor position displayed on the computer graphics overlay as a function of a size of the hand and a position of at least one of the hand and fingers of the hand.

In an embodiment, the display module is configured to de-activate the display of the computing device when an end gesture is detected.

In an embodiment, the display is a transparent display.

In another embodiment, the display is a non-transparent display.

In another embodiment, the display is a wearable display.

In another aspect, a method for controlling a computing device through gestures is disclosed. The gestures are hand gestures. The method includes detecting a start gesture, and activating a display of the computing device based on the detection of the start gesture. The method further includes detecting a toggle gesture, and analyzing the toggle gesture. The method furthermore includes switching a first interface of the computing device to a second interface based on the analysis of the toggle gesture. The method also includes de-activating the display when an end gesture is detected.

In embodiments of the present disclosure, the term “hand gesture” generally refers to a gesture that a user makes using his/her hands and/or fingers. The gesture can either be a still gesture in which the user's hands and/or fingers are in a particular pose without any substantial movement or be a motion gesture in which the user's hands and/or fingers move in a particular manner. Examples of still gestures include, but are not limited to, a closed first of the user, an open palm of the user, a thumbs-up gesture of the user, a thumbs-down gesture of the user, closed palm with thumb up, closed palm with thumb down and closed fist. Examples of motion gestures include, but are not limited to, a waving gesture, a sliding gesture and a swiping gesture. The toggle gestures, start gestures and end gestures are typically hand gestures as defined above.

### BRIEF DESCRIPTION OF THE FIGURES

The foregoing summary, as well as the following detailed description of preferred embodiments, is better understood when read in conjunction with the appended drawings. For the purposes of illustration, there is shown in the drawings exemplary embodiments; however, the present disclosure is not limited to the specific methods and instrumentalities disclosed. In the drawings:

FIGS. 1A-1D illustrates environments where various embodiments of the present disclosure may function;

FIG. 2 illustrates a block diagram of a computing device, in accordance with various embodiments of the present disclosure;

FIG. 3 illustrates an example of a use case of using a system for controlling a computing device using one or more gestures, in accordance with an embodiment of the present disclosure;

FIG. 4 illustrates another example of a use case of using a system for controlling a computing device using one or more gestures, in accordance with an embodiment of the present disclosure;

FIG. 5 illustrates an example of a use case of a system using a toggling gesture using two hands for changing one or more modes, in accordance with an embodiment of the present disclosure;

FIG. 6 illustrates yet another example of a use case of a system using another toggling gesture for switching among the one or more modes, in accordance with an embodiment of the present disclosure;

FIG. 7 illustrates yet another example of a use case of a system for controlling a computing device, in accordance with an embodiment of the present disclosure;

FIG. 8 is another example of a use case of a system for controlling a computing device, in accordance with an embodiment of the present disclosure;

FIGS. 9A-9B is a flowchart illustrating an exemplary method for controlling a computing device with a number of hand gestures, in accordance with an embodiment of the present disclosure;

FIGS. 10A-10B is a flowchart illustrating another exemplary method for controlling a computing device with a number of hand gestures, in accordance with another embodiment of the present disclosure;

FIG. 11 is a flowchart illustrating an exemplary method for controlling movement of a cursor using hand gestures on a computer graphics overlay, in accordance with an embodiment of the present disclosure;

FIG. 12 is a flowchart illustrating an exemplary method for controlling a computing device by mapping one or more actions based on hand gestures, in accordance with an embodiment of the present disclosure; and

FIG. 13 is a flowchart illustrating an exemplary method for controlling a computing device based on one or more toggle gestures, in accordance with an embodiment of the present disclosure.

### DETAILED DESCRIPTION

The present disclosure is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

The functional units described in this specification have been labeled as systems or devices. A module, device, or a system may be implemented in programmable hardware devices such as, processors, digital signal processors, central processing units, field programmable gate arrays, programmable array logic, programmable logic devices, cloud processing systems, or the like. The devices/modules may also be implemented in software for execution by various types of processors. An identified device/module may include executable code and may, for instance, comprise one or more physical or logical blocks of computer instructions, which may, for instance, be organized as an object, procedure, function, or other construct. Nevertheless, the executable of an identified device/module need not be physically located together, but may comprise disparate instructions stored in different locations which, when joined logically together, comprise the device and achieve the stated purpose of the device.

Indeed, an executable code of a device could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

The device, module, or system for controlling a computing device through a number of gestures may be a software, hardware, firmware, or combination of these. The device, module, or the system is further intended to include or otherwise cover all software or computer programs capable of performing the various heretofore-disclosed determinations, calculations, etc., for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a Blue-Ray Disc, CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

As referred to herein, the term “computing device” should be broadly construed. It can include any type of interactive mobile device, for example, a digital eyeglass, a wearable necklace, a smart glass, a Google Glass™, a head-mounted optical device, a smart phone, a cell phone, a pager, a personal digital assistant (PDA, e.g., with GPRS NIC), a mobile computer with a smart phone client, a television, a wireless communication-enabled photo frame, or the like. A computing device can also include any type of conventional computer, for example, a desktop computer or a laptop computer. A typical mobile device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks, or other client applications. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on a mobile device, the examples may similarly be implemented on any suitable computing device.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of the network may also include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

As referred to herein, an “interface” is generally a system by which users interact with a computing device. An interface can include an input for allowing users to manipulate a computing device, and can include an output for allowing the system to present information and/or data, indicate the effects of the user's manipulation, etc. An example of an interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or arrow keys for moving a cursor to highlight and select the display object.

Operating environments in which embodiments of the present disclosure may be implemented are also well known. In a representative embodiment, a computing device, such as a mobile device, is connectable (for example, via WAP) to a transmission functionality that varies depending on implementation. Thus, for example, where the operating environment is a wide area wireless network (e.g., a 2.5G network, a 3G network, or a 4G network), the transmission functionality comprises one or more components such as a mobile switching center (MSC) (an enhanced ISDN switch that is responsible for call handling of mobile subscribers), a visitor location register (VLR) (an intelligent database that stores on a temporary basis data required to handle calls set up or received by mobile devices registered with the VLR), a home location register (HLR) (an intelligent database responsible for management of each subscriber's records), one or more base stations (which provide radio coverage with a cell), a base station controller (BSC) (a switch that acts as a local concentrator of traffic and provides local switching to effect handover between base stations), and a packet control unit (PCU) (a device that separates data traffic coming from a mobile device). The HLR also controls certain services associated with incoming calls. Of course, the present disclosure may be implemented in other and next-generation mobile networks and devices as well. The mobile device is the physical equipment used by the end user, typically a subscriber to the wireless network. Typically, a mobile device is a 2.5G-compliant device, a 3G-compliant device, or a 4G-compliant device that includes a subscriber identity module (SIM), which is a smart card that carries subscriber-specific information, mobile equipment (e.g., radio and associated signal processing devices), a user interface (or a man-machine interface (MMI)), and one or more interfaces to external devices (e.g., computers, PDAs, and the like). The mobile device may also include a memory or data store.

In another exemplary operating environment, the computing device, electronic devices as described herein may communicate with each other in any suitable wired or wireless communications network. For example, the computing devices may include suitable I/O communications hardware, software, and/or firmware for communicating with each other via a wireless communications network such as BLUETOOTH® technology or IEEE 802.11 technology. The computing devices may also be suitably equipped for wired communications with one another via, for example, a telephone line.

In various embodiments of the present disclosure, definitions of one or more terms that will be used in the document are provided below.

As used herein, a “computing device” as used herein includes a single device or a combination of multiple devices, which may be capable of communicating, and exchanging one or messages with other devices present in a network.

As used herein, a “User Interface” or a “Graphical User Interface” (GUI) can include an interface on a display, such as a screen, of the computing device enabling a user to interact with the device or computing device. The display may be an opaque screen which is not a see-through display, or a transparent screen, video augmented reality. In one embodiment, the display is see-through and the interface may be overlapped over real objects in the display by the display module.

Further, as used herein, a “database” refers to a single or multiple modules or devices including hardware, software, firmware, or combination of these that can be configured to store pre-defined gestures, pre-defined control commands or actions, details about electronic devices, and so forth.

As used herein, a “detection module” refers to a single or multiple modules or devices including hardware, software, firmware, or combination of these that can be configured to detect one or more gestures.

Further, as used herein, an “image capturing module” refers to a single or multiple modules or devices including hardware, software, firmware, or combination of these that can be configured to capture images for example, images of hand gestures. The hand gesture recognition system may include for example Time-of-Flight (ToF) cameras, the use of textured light, and other depth or proximity sensing devices.

Furthermore, as used herein, an “analyzing module” refers to a single or multiple modules or devices including hardware, software, firmware, or combination of these that can be configured to process and compare one or more gestures with pre-defined gestures.

As used herein, a “controlling module” refers to a single or multiple modules or devices including hardware, software, firmware, or combination of these that can be configured to control one or more settings of a computing device.

Further, as used herein, an “access managing module” refers to a single or multiple modules or devices including hardware, software, firmware, or combination of these that can be configured to check for permission for accessing the electronic device.

As used herein, a “session managing module” refers to a single or multiple modules or devices including hardware, software, firmware, or combination of these that can be configured to establish or manage communication session between a computing device and one or more electronic devices.

Further, as used herein, a “display module” refers to a single or multiple modules or devices including hardware, software, firmware, or combination of these that can be configured to display a computer graphics overlay.

Furthermore, as used herein, an “Input/Output module” refers to a single or multiple modules or devices including hardware, software, firmware, or combination of these that can be configured to receive an input from a user or to present an output to the user.

As used herein, a “central processing unit” refers to a single or multiple modules or devices including a software, hardware, firmware or combination of these, that is configured to process and analyze a number of gestures.

Further, as used herein, a “memory” refers to a single or multiple modules or devices including hardware, software, firmware, or combination of these that can be configured to store instructions that can be executed by the central processing unit or other modules.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item. The terms toggle gesture and start gesture may also be used interchangeably, depending on the context.

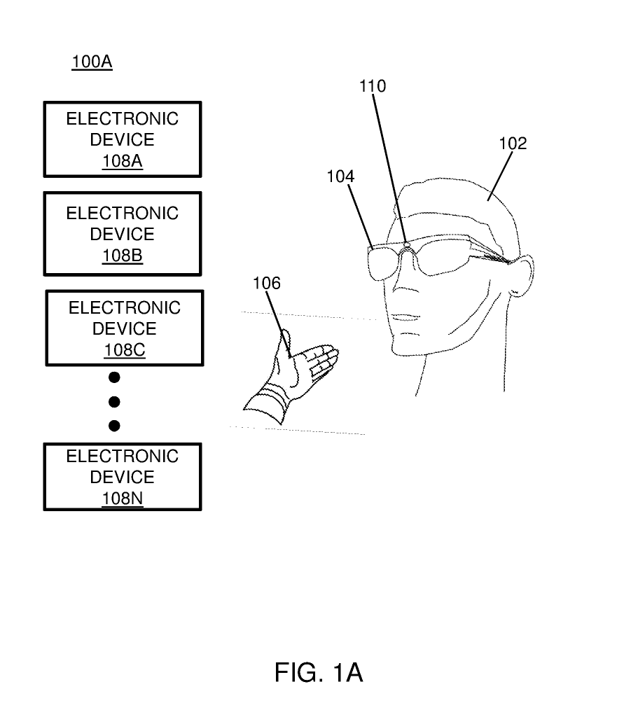

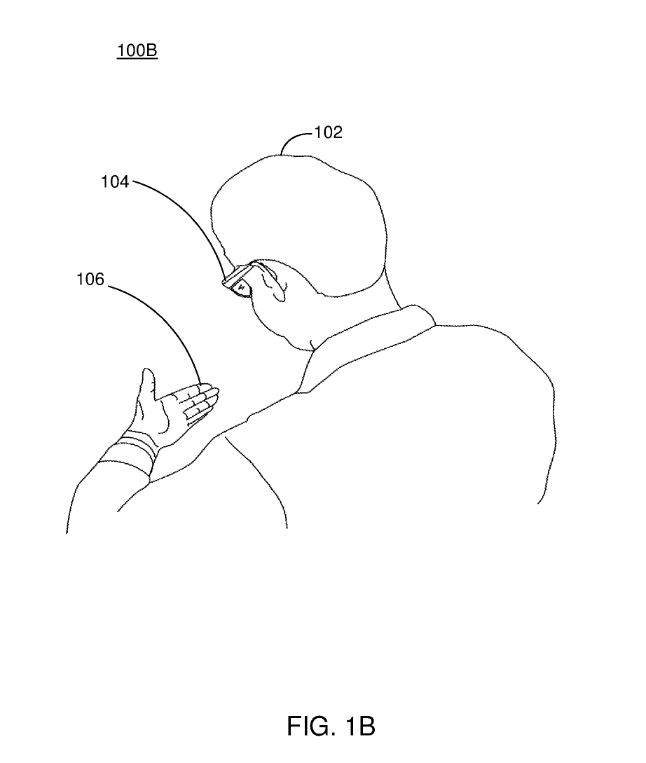

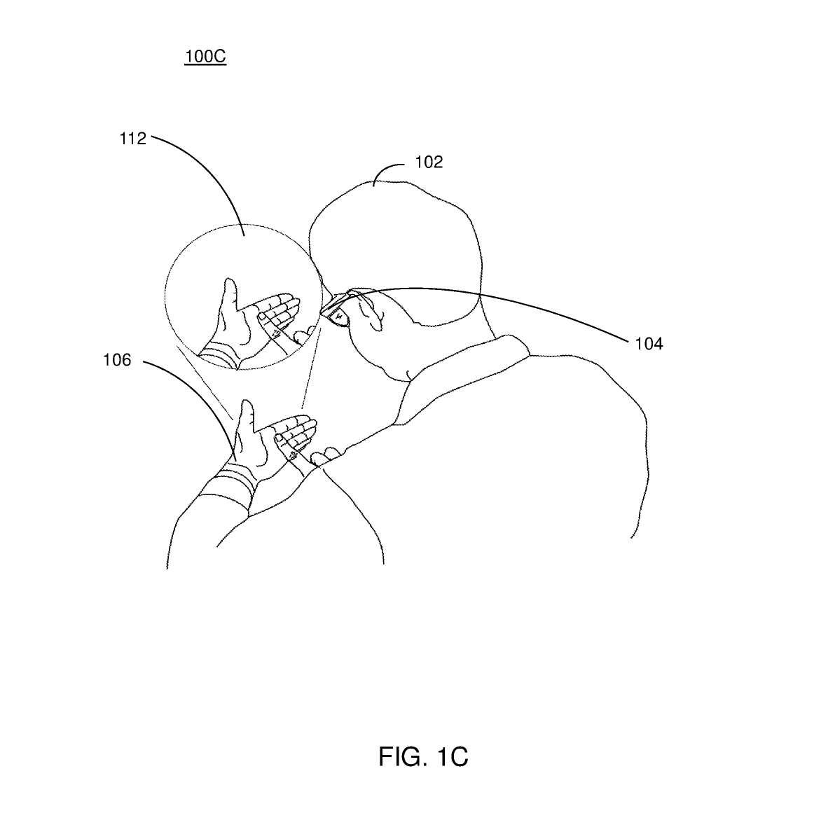

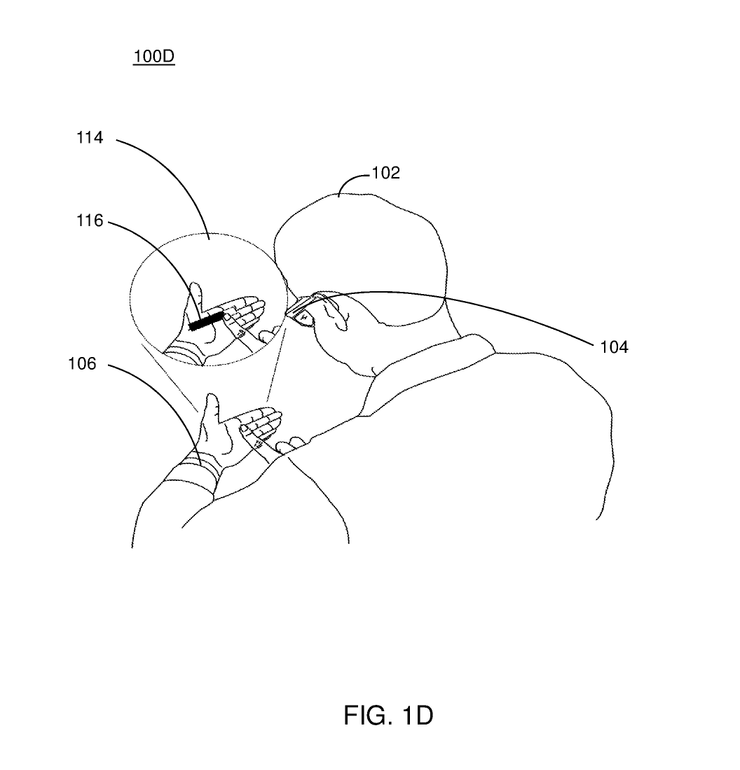

FIGS. 1A-1D illustrates environments 100A-100D, where various embodiments of the present disclosure may function. As shown, the environment 100A primarily includes a user 102 having one or more hands 106, a computing device 104, and a number of electronic devices 108A-108N. The computing device 104 can be an interactive computing device associated with the user 102. The computing device 104 may include an integrated processing device (not shown). In an embodiment of the present disclosure, the interactive computing device 104 is a wearable computing device. Hereinafter, due to similarity in functionality and structure, the terms computing device, the wearable computing device, and interactive computing device are used interchangeably. In an embodiment of the present disclosure, the computing device 104 is a device worn on head of the user 102 head with a screen/display in front of eyes that displays information like smart-phones. Examples of the computing device 104 may include, but are not limited to, digital eyeglasses, a wearable necklace, Google glass, and a head-mounted optical device. The computing device 104 can be any other wearable device configured to integrate an image capturing module, and/or one or more sensors. In some embodiments, the computing device may have networking capabilities to transmit/receive data. The Google Glass™ is associated with a wearable technology having an optical head-mounted display (OHMD). In an embodiment of the present disclosure, the computing device 104 may contain the display, a microphone, or a speaker.

The environment 100A shows the user 102 wearing the computing device 104 and capable of interacting with one or more of the electronic devices 108A-108N through one or more hand gestures. The user 102 can also interact with the computing device 104 via one or more hand gestures.

The environment 100B shows a back side of the user 102 wearing the computing device 104 in form of goggles and display is a transparent or a see-through display, the user 102 is able to see his/her hands 106. The user 102 can control the computing device 104 via his/her hand gestures. For example, the user 102 may switch off or switch on a display of the computing device 104 using pre-defined gestures. Further, the user 102 may change or toggle one or more modes of operations of the computing device 104 via the pre-defined gestures. In emulating commonly used user interface mechanisms, such as keyboard, there is different modes can be toggled through on or more toggle gestures. In a keyboard, such modes are keyboard layout (alphanumerical or numerical), uppercase/lowercase, and so on.

Examples of the toggle gesture may include, such as, but not limiting to, an open palm, making a fist, opening palm, moving palm upside down, waving hand, bringing hand close to the display, and so forth. When mode switching occurs, it is visualized in immediately on the display. The toggle gestures may cause the display to switch between the one or more control options or interfaces in a round-robin way.

The environment 100C shows a back side of the user 102 wearing the computing device 104 in form of goggles and display is see-through display, the user 102 is able to see a zoomed view 112 of his/her hands 106.

The environment 100D shows a back side of the user 102 wearing the computing device 104 in form of goggles and display is see-through display, the user 102 is able to see a zoomed view of a computer graphics overlay 114.

The computing device 104 is configured to detect the one or more hand gestures. The computing device 104 is also configured to detect the one or more gestures of the hand 106 even when the user 102 is wearing the gloves or there is less light. Further, the computing device 104 may include a wearable or non-wearable display device. In some embodiments, the computing device 104 may include a dark or non-transparent surface that is mounted behind the computing device 104 to block the light. While they are worn by the user 102 as eye ware, they are blocking the user 102 from seeing the environment in front. However, they can still provide ways to sense the surrounding and present it to the user 102 in a modified form. Those skilled in the art call it augmented virtuality, and it refers as presenting the virtual world with some real world objects. The real objects are usually the user's hands 106 or other pre-defined objects that are useful in the virtual environment.

Further, the user 102 may use the hands 106 for controlling and interacting with the computing device 104. The environment 100A shows the user 102 wearing the computing device 104 and capable of interacting with the computing device 104 through the hand gestures. The user 102 may access information and interact with the computing device 104 while driving, operating on a patient, controlling industrial equipment, cooking or anything else that involves human computer interaction.

In an embodiment, the computing device 104 may allow the user 102 to interact with other devices or electronic devices 108A-108N. The user 102 may use the hands 106 for controlling and interacting with the electronic devices 108A-108N. The user 102 may control, like switch on or switch off, change operation modes, remotely of the other devices with the gestures such as, gestures including either one or both hands 106. Examples of the electronic devices 108A-108N, may include, but are not limited to, a television (TV), a smart phone, a music system, a microwave, a lighting system, a computer, an electronic fan, a washing machine, an electronic home appliance, an air conditioner, and so forth. The hands 106 may include a first hand and a second hand. Further, in some embodiments, the gestures are done using one of the hands 106. For example, the whole first hand moves with reference to the image capturing device 206 or only fingers of the first hand moves. In alternative embodiments, the gestures are gestures done using two or more hands. In one embodiment, the first hand 106 acts as a reference and the second hand or one or more fingers of the second hand moves with reference to the first hand to create gestures and control the computing device 104. Further, the cursor will move based on the movement of both the hands 106 on the computer graphic overlay. The first hand may remain static and the second hand may move with reference to the first hand.

The computing device 104 may include or may be associated with a suitable image capturing device such as, a camera. The camera may or may not be an integral part of the computing device 104. The user 102 can interact with the computing device 104 and/or other electronic devices 108A-108N as long as the camera of the electronic devices 108A-108N or a camera of worn by the user 102 can view the hands 106. It may be noted that in FIG. 1A, the user 102 interacts with the computing device 104; however those skilled in the art would appreciate that more number of users may interact with the computing device 104.

The computing device 104 includes the display and in case of an augmented reality display device, the computing device 104 may include the computer graphics overlay 114 as shown in FIG. 1D. The display may consume energy and is usually the computing device 104 is battery operated. The display of the computing device 104 may be switched on or switched off by using the hand gestures. The hand gestures for controlling the display may be pre-defined by the user 102. In the pre-defined gestures, the hands 106 may be static or may be a moving for example, towards face/away from the face, from left to right/up-down or in any combination. In some embodiments, the gesture activating the display is easily detectable to allow the gesture recognition part of algorithm to execute with slower processor speed to save power. The user 102 may switch on or switch off display of the computing device 104 by pre-defined hand gestures for example, a start gesture and an end gesture. This in turn may save power. In some embodiments, the computing device 104 operates on a battery. Switching on and switching off of the display of the computing device 104 may save power, and therefore the battery of the computing device 104 may be used for a long time. Though, the display is switched off or switched on, but the computing device 104 or the sensors 110 of the computing device 104 continuously keeps on detecting or capturing image or spatial data.

The computing device 104 may also provide a feedback to the user 102. For example, a car with a centrally mounted camera and display on windshield, or a house with a system of cameras and a voice feedback, or a feedback on the TV and the like.

In an embodiment of the present disclosure, the hands 106 of the user 102 move in air to give some signal or command to one or more of the electronic devices 108A-108N. For example, if the user 102 opens, waves or closes the hands, then a signal corresponding to the gesture is issued. In another embodiment of the present disclosure, the hands 106 of the user 102 are used to control one or more settings or features of the computing device 104 or the electronic devices 108A-108N in an analogue way. This is related to controlling quantities in cases where number input is not quick and flexible enough. Examples of the one or more settings or features may include, but is not be limited to, sound volume, speed, height, power, direction, and steering. The controlling of remote devices is done via overlaying a user interface element, like a slider, on the OHMD and controlling it with some gestures.

In an embodiment of the present disclosure, the computing device 104 is a portable computing device. The portable computing device may include a camera configured to capture a sequence of images, a memory and a central processing unit. The central processing unit may be configured to analyze sequence of images and identify a hand gesture of the user 102 in the sequence of images, compare the identified hand gesture with a set of pre-defined hand gestures, and execute an action mapped to a pre-defined hand gesture.

Further, the computing device 104 includes one or more sensors 110 configured to capture spatial data and produce a two dimensional and/or three dimensional data map of the environment. This data map may then be analyzed or processed further by the computing device 104. In some embodiments, the sensors 110 are part of an image capturing module such as, the camera of the computing device 104. Examples of the one or more sensors 110 may include, but are not be limited to gyroscope, precision sensors, proximity sensors and accelerometer.

Examples of the image capturing module may include, but are not limited to, a camera, an infrared camera, scanning range detector devices (For example, LiDAR device) that provides a depth map of the image or environment.

The environment 100D shows the computer graphics overlay 114, which is visible to the user 102 via the display of the computing device 104. The display can be a wearable and video see through or a transparent display (or an optical see-through display) such as that of the Google Glass™. In some embodiments, the display may be a wearable and non-transparent display device, such as that of an Oculus Rift, which is configured to project the computer graphic overlay 114 to a user visual field or viewable area. In alternative embodiments, the display is part of a non-wearable device such as the mobile phone, tablet computer, etc., and includes a front facing camera or sensor.

The image capturing module is configured to capture a sequence of images including multiple images of one or more gestures on the computer graphics overlay 114. The computer graphics overlay 114 may be a user interface in the viewable area of the computing device 104. In some embodiments, the computing device 104 may include a dark or non-transparent surface that is mounted behind the computing device 104 to block the light. While they are worn by the user 102 as eye ware, they are blocking the user 102 from seeing the environment in front. However, they can still provide ways to sense the surrounding and present it to the user 102 in a modified form. Those skilled in the art call it augmented virtuality, and it refers as presenting the virtual world with some real world objects. The real objects are usually the user's hands 106 or other pre-defined objects that are useful in the virtual environment.

The computing device 104 may store a number of pre-defined gestures and one or more actions or control commands to be performed corresponding to the pre-defined gestures, access permission related information for the electronic devices 108A-108N, and so forth. The computing device 104 may detect a gesture such as, a start gesture. Examples of the start gesture may include a hand gesture, such as, but not limiting to, opening a fist, an open palm, a closed first with at least one of finger or thumb in open position, waving hand, and so forth. The start gesture may be pre-defined or set by the user 102. For example, the user 102 may set moving an open palm towards left as the start gesture. The computing device 104 may continue detecting gestures but may switch on its power or switch off its power by detecting the start gesture or an end gesture, respectively. The end gesture may be pre-defined or set by the user 102. For example, the user 102 may set moving an open palm towards right or back to normal as the end gesture. Further, the computing device 104 can detect any gesture only when the gesture is performed in a viewing area (or user visual field) or a user interface which is viewable via the computing device 104.

In an embodiment of the present disclosure, the user interface is a variant of a physical user interface device including keyboard having alternate appearances including uppercase mode, lowercase mode, numerical mode, different language modes and the like. In another embodiment of the present disclosure, the user interface is a variant of a physical user interface device including television having alternative control modes including sound volume up/down, channel selection and the like.

As soon the start gesture is detected, the computing device 104 may start capturing an image sequence including multiple images capturing one or more gestures on the computer graphics overlay 114 or the user interface. The image capturing module or the sensor 114 continuously detects the images, but when the start gesture is detected the power of the computing device 104 is switched on and the power is switched off on detection of the end gesture so as to save power. The user interface may be a virtual interface viewable from the computing device 104. The computing device 104 may be configured to extract the one or more gestures from the images of the sequence of images. The computing device 104 is also configured to determine one or more pre-defined gestures matching the detected one or more gestures by comparing the detected one or more gestures with the pre-defined gestures. The computing device 104 may also be configured to determine one or more control commands or actions to be executed corresponding to the one or more gestures for controlling the one or more of the electronic devices 108A-108N.

In some embodiments, the computing device 104 checks for permission to access or connect with one or more electronic devices 108A-108N through gestures. Further, the one or more control commands or options may be displayed to the user 102 at the computer graphics overlay 114 (or the user interface). The user's hands 106 may be overlaid at the computer graphics overlay 114 or the user interface by the computing device 104 for allowing the user 102 to control the one or more settings of the electronic devices 108A-108N. The control command option may include options for switching on or off the electronic devices 108A-108N, increasing/decreasing the volume, managing the temperature, and so forth. A data map 116 shows a mapping of a finger overlaid with the user interface in accordance with movement of the finger on the hand 106. The image capturing module 206 may capture the coordinates based on the map 106. The data map 116 is shown to be a two dimensional map but the data map 116 may be a three dimensional map.

The computing device 104 may use one or more algorithms for detecting gesture. The one or more algorithms may include at least one of an adaptive real-time skin detector algorithm based on hue thresholding, algorithms based on the color of the hand and algorithms based on pattern recognition.

Further, the computing device 104 may store a status of the electronic devices 108A-108N being controlled in order to initiate graphics on the computer graphics overlay 114 properly.

Further, the user 102 may change or switch among different modes of operation by toggling among one or more hand gestures on the user interface. Examples of the modes may include, but are not limited to, a lower case keyboard mode, an uppercase keyboard mode, a symbol based keyboard mode, a video mode, an audio control mode, an audio mode, and so forth. In an embodiment, the mode includes a single hand operation mode for controlling the electronic devices 108A-108N or the computing device 104. In the alternative embodiment, the mode is a double hands mode for controlling the electronic devices 108A-108N or the computing device 104 via the two hands.

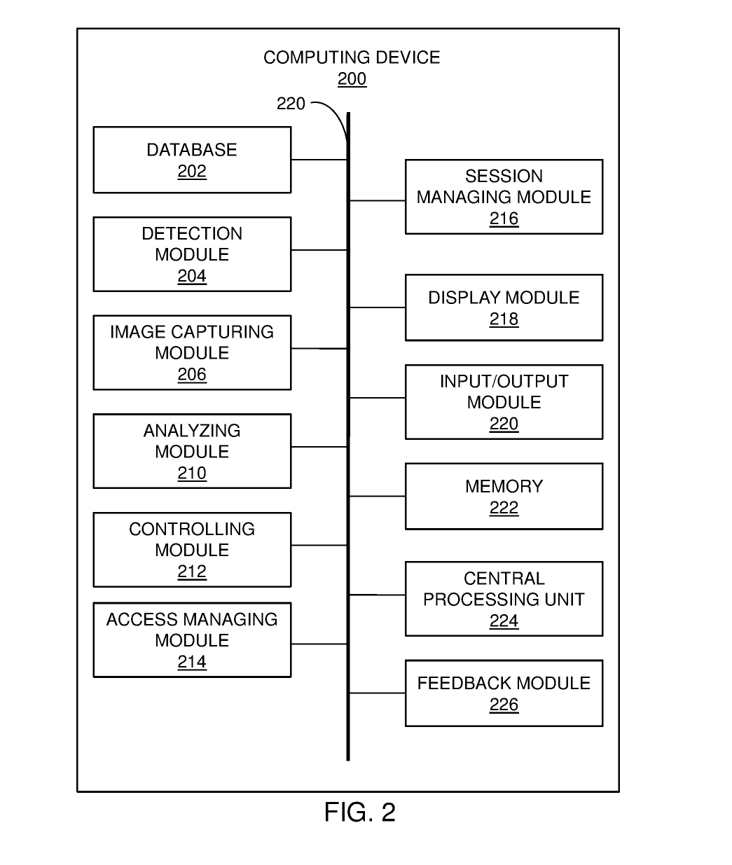

FIG. 2 illustrates a block diagram of a computing device 200, in accordance with an embodiment of the present disclosure. It may be noted that to explain system elements of FIG. 2, references will be made to the FIG. 1. The hands 106 of the user 102 move to give the signals or the commands to the computing device 104. The computing device 200 is similar in structure and functionality to the computing device 104. In an embodiment of the present disclosure, the movement of the hands 106 refers to closed fist, open palm, thumbs up, or any other related hand pose that may control functioning of the computing device 104.

As shown, the computing device 104 primarily includes a database 202, a detection module 204, an image capturing module 206, an analyzing module 210, a controlling module 212, an access managing module 214, a session managing module 216, a display module 218, an Input/Output module 220, a memory 222, a central processing unit 224, and a feedback module 226. In an embodiment, the image capturing module 206 is a camera capable of capturing images and/or recording videos of gestures. The modules are connected to and can interact with each other via a bus 208. The bus 208 may be a communication system including wires etc to enable different modules to interact and exchange data with each other.

The database 202 may store machine readable instructions which are executed by the modules 204-226. The database 202 also stores pre-defined gestures, pre-defined control commands, pre-defined actions, modes of operations, access permission related information, and identity information of the computing device 104 and the of the electronic devices 108A-108N. The execution of the machine readable instructions enables the modules 204-226 to perform some steps needed to identify and recognize the gestures made by the hands 106 of the user 102 and control the electronic devices 108A-108N. Each of the modules 202-226 can be a software, hardware, firmware, devices, or combination of these. Further, the modules 202-226 may be standalone product, a part of operating system, a library component for software developers to include gesture recognition capabilities and the like.

The detection module 204 is configured to detect the gestures of the user 102. In some embodiments, the gestures are gestures of the hands 106 of the user 102. In an embodiment of the present disclosure, the detection module 204 detects whether the gestures of the hands 106 are near or far away from the image capturing module 206 of the computing device 104. For example, if at least one of the hands 106 of the user 102 is near to the computing device 104, a signal is generated. Similarly, when the at least one of the hands 106 of the user 102 is away from the computing device 104, another signal is generated.

The detection module 204 may be configured to recognize or detect a start gesture. The image capturing module 206 may be activated post detection of the start gesture. The start gesture may be an open palm, an open palm orthogonal to viewing direction with fingers spread, and a first with thumbs up. In some embodiments, the start gesture includes bringing a hand to first and opening it. The detection module 204 is further configured to detect an end gesture. The end gesture may include a closed palm gesture, a thumb down gesture, a first gesture, and the like. The image capturing module 206 may be de-activated when the end gesture is detected.

In an embodiment, the image capturing module 206 is configured to recognize the hands 106 of the user 102 after an initial gesture or the start gesture. The image capturing module 206 may capture an image or a sequence of images including multiple images of the gestures of the hands 106 and store the image or the image sequence in the database 202. In an embodiment of the present disclosure, the image capturing module 206 is a separate device and is not part of the computing device 104, and the user 102 may have to wear a camera to capture the images of the gestures of the hands 106.

In an embodiment, the image capturing module 206 includes one or more sensors, such as the sensors 110, configured to capture spatial data based on a movement of the hands 106 in a viewable area of the computing device 104. Examples of the image capturing module 206 may include, but are not limited to, a camera, an infrared camera, scanning range detector devices (For example, LiDAR device) that provides a depth map of the image or environment. The analyzing module 210 is configured to analyze the spatial data and produce a two dimensional or three dimensional data map of the environment. This data map may then be analyzed or processed further by the analyzing module 210 or other modules as discussed with reference to FIG. 2. The analyzing module 210 is also configured to determine at least one pre-defined action corresponding to the at least one of the 2 dimensional and the 3 dimensional data map. The controlling module 212 is configured to execute the at least one pre-defined action.

The analyzing module 210 is configured to determine one or more pre-defined hand gestures based on the detected hand gestures. The analyzing module 210 is also configured to determine one or more pre-defined control commands corresponding to the one or more pre-defined hand gestures, wherein the controlling module is configured to execute the one or more pre-defined control commands.

The display module 218 is configured to activate a display associated with the computing device 200 when the start gesture is detected. The display module 218 is also configured to display the computer graphics overlay 114 on a display of the computing device 104. Further, the hand 106 of the user 102 is mapped onto the computer graphics overlay 114.

The detection module 204 is also configured to detect a toggle gesture. The analyzing module 210 is configured to analyze the toggle gesture. The analyzing module 210 is also configured to compare the detected toggle gesture with the pre-defined gestures stored in the database 202. The pre-defined gestures may be defined by the user.

The controlling module 212 is configured to switch a first interface of the computing device 104 to a second interface based on the analysis. The first interface may be based on a mode of operation. In an exemplary scenario, the first interface is a lowercase keyboard interface, and the second interface is an uppercase keyboard. Examples of the mode of operation may be like, but not limiting to, a lowercase keyboard mode, an uppercase keyboard mode, a volume control mode, a channel control mode, and so forth. In some embodiments, the first interface and the second interface are displayed on the computer graphics overlay 114.

The controlling module 212 is further configured to control a movement of a cursor on the computer graphics overlay based on one or more hand gestures of the user 102.

In some embodiments, the display module 218 is further configured to de-activate the display of the computing device 104 when an end gesture is detected. In an exemplary scenario, the start gesture may be a thumb up gesture and the end gesture may be a thumb down gesture.

The image capturing module 206 is configured to capture a sequence of images including multiple images of one or more gestures on the computer graphics overlay 114. The computer graphics overlay 114 may be a user interface in the viewable area of the computing device 104. In some embodiments, the computing device 200 may include a dark or non-transparent surface that is mounted behind the computing device 200 to block the light. While they are worn by the user 102 as eye ware, they are blocking the user 102 from seeing the environment in front. However, they can still provide ways to sense the surrounding and present it to the user 102 in a modified form. Those skilled in the art call it augmented virtuality, and it refers as presenting the virtual world with some real world objects. The real objects are usually the user's hands 106 or other pre-defined objects that are useful in the virtual environment.

The analyzing module 210 is configured to extract or determine the one or more gestures from the images or the image sequence. The analyzing module 210 may analyze the images or the spatial data to identify one or more devices to be controlled. There may be multiple devices identified by the analyzing module 210 from the image sequence or the data that need to be controlled. In such scenario, the user 102 may select one or more of the multiple devices or features of the computing device 200 to be controlled from the images or the data extracted by the analyzing module 210. In alternative embodiments, the one or more of the multiple devices is selected based on the pre-defined preferences of the user 102 stored in the database 202. In some embodiments, the analyzing module 210 is a remotely located device and is not part of the computing device 104.

The analyzing module 210 may be configured to analyze the images or the image sequence. The analyzing module 210 is configured to compare the detected one or more gestures with the pre-defined gestures stored in the database 202. The analyzing module 210 is further configured to determine one or more pre-defined gestures matching with the detected one or more gestures based on the comparison. In some embodiments, the analyzing module 210 is further configured to determine a number of control commands corresponding to the determined one or more pre-defined gestures. The analyzing module 210 may use one or more algorithms for detecting gesture. The one or more algorithms may include at least one of an adaptive real-time skin detector algorithm based on hue thresholding, algorithms based on the color of the hand and algorithms based on pattern recognition.

The display module 218 is configured to display one or more control options on the user interface of the display associated with the computing device 200. The user interface may include the computer graphics overlay 114. In an embodiment of the present disclosure, the user interface is a variant of a physical user interface device including keyboard having alternate appearances including uppercase mode, lowercase mode, numerical mode, different language modes and the like. In another embodiment of the present disclosure, the user interface is a variant of a physical user interface device including television having alternative control modes including sound volume up/down, channel selection and the like.

Further, the display may be an opaque screen (non-transparent), which is not a see-through display or a transparent screen. In one embodiment, the display is see-through and the interface may be overlapped on real objects by the display module 218. The control options are the options for controlling the electronic devices 108A-108N. The user interface can be the computer graphics overlay 114. In an embodiment, the user interface is a variant of a physical user interface device with keyboard having alternate appearances, the alternate appearances including at least one of an uppercase mode, a lowercase mode, a numerical mode and different language modes. In an alternative embodiment, the user interface is a variant of a physical user interface device with television having alternative control modes. The alternative control modes may include at least one of sound volume up/down, and channel selection. The computing device 200 can be a wearable device as discussed with reference to FIG. 1. The user 102 can select one or more control options through one or more hand gestures. The Input/Output module 220 is configured to receive a selection of at least one control options from the user 102.

Further, the display of the computing device 200 may be a wearable and see through or a transparent display such as that of the Google Glass™. In some embodiments, the display may be a wearable and non-transparent display device, such as that of an Oculus Rift, which is configured to project the computer graphics overlay 114 to a user visual field or viewable area. In alternative embodiments, the display is part of a non-wearable device such as the mobile phone, tablet computer, etc., and includes a front facing camera or sensor.

The controlling module 212 may also be configured to overlay the hands 106 of the user 102 on the user interface to allow the user 102 to control the one or more of the electronic devices 108A-108N. In an embodiment, a cursor is displayed or mapped on the user interface, such as the computer graphics overlay 114, based on the hands 106. The position of the cursor may change depending on the position of the hand 106 or a part of the hand 106. In some embodiments, the user 102 may define position of the cursor based on pre-defined gestures. The controlling module 212 is further configured to control a movement of the cursor by moving the hands 106 within the computer graphics overlay 114. The controlling module 212 is configured to control one or more settings or features of one or more of the electronic devices 108A-108N based on the determined one or more pre-defined gestures or/and the pre-defined control commands. The controlling module 212 may also be configured to change the one or more settings of the at least one electronic device based on at least one of a selection of at least one of the control options by the user 102 and detection of one or more gestures on the user interface.

In an embodiment, the controlling module 212 is configured to control a cursor movement by moving an open palm within the computer graphics overlay 114 or the user interface. A cursor position displayed on the computer graphics overlay 114 may be calculated as a function of a size of the hand and a position of at least one of the hand and fingers of the hand. In an embodiment, an appearance of the cursor on the computer graphics overlay 114 is altered if the open palm or the start gesture is not recognized.

The modules 202-226 may perform one or more steps as disclosed above such as analyzing the images using one or more computer vision algorithms. For example, various algorithms can be used including an adaptive real-time skin detector algorithm based on hue thresholding, algorithms based on the color of the hand and algorithms based on pattern recognition and the like. The one or more computer vision algorithms are tailored to recognize the hands 106 in a viewport of the image capturing module 206, specifically various shapes of the hands 106, sequence of the various shapes and sizes. The size of the detected pose in the image is based on distance of the hands 106 from the image capturing module 206. For example, if the hands 106 are in proximity to the image capturing module 206, the image will appear bigger and moving it in the camera frame will be smaller, hence lowering the resolution of the cursor. Further, if the hands 106 are a little far away from the image capturing module 206, the image will appear smaller and hence enhancing the resolution.

In an embodiment, the memory 222 stores the algorithms, instructions etc. for per forming the disclosed steps or processes. The central processing unit (CPU) 224 may execute non-transitory computer or machine readable instructions for carrying out processes. The CPU 224 may be configured to perform a set of steps such as, analyzing sequence of images; identifying a hand gesture of the user 102 in the sequence of images; comparing the identified hand gesture with a set of pre-defined hand gestures stored in the database 202; and executing an action mapped to a pre-defined hand gesture. The action may be a control action for controlling one or more settings of the electronic devices 108A-108N. The database 202 stores the actions corresponding to the pre-defined gestures.

In addition, the gestures analyzed by the analyzing module 210 by using the computer vision algorithms need to adapt to variety of hand shapes of the user 102. The analyzing module 210 may also recognize one or more control commands associated with the analyzed gestures of the hands 106. Further, the analyzing module 210 may map the recognized commands in to a number of pre-defined actions associated with the corresponding one or more control commands. In an embodiment of the present disclosure, the analyzing module 210 uses a teaching phase to map the gestures into the pre-defined actions. The database 202 may also store the pre-defined actions.

In an embodiment of the present disclosure, the computing device 104 includes a number of control options including volume up/down, display on/off and the like. Each of the control options may have associated computer functionalities and may employ applications including games, which may have multiple control options. In an embodiment of the present disclosure, controlling the computing device 104 or one or more other external electronic devices 108A-108N employs some known method of receiving information required to render a control user interface and associated commands, rendering the user interface, recognizing the commands and sending the commands back to the device.

The access managing module 214 may be configured to check for an access permission to communicate with the electronic devices 108A-108N. In an embodiment, the access managing module 214 may check for the access permission post detection of the start gesture. The session managing module 216 is configured to establish a communication session of the wearable computing device 104 with at least one of the electronic devices 108A-108N based on the checking of the access permission. For example, a communication session is established between the computing device 104 and the electronic device 108A when the computing device 104 has an access permission to communicate with the electronic device 108A. Further, the session managing module 216 is configured to end the communication session of the computing device 104 with the at least one of the electronic devices 108A-108N when the end gesture is detected.

The feedback module 226 is configured to provide a feedback to the user 102 based on the pre-defined actions performed corresponding to the one or more control commands. The feedback module 226 may provide the feedback on a visual display or other forms of acoustic or vibration feedback platforms. The display may be an opaque screen, which is not a see-through display, or a transparent screen. In one embodiment, the display is see-through and the interface may be overlapped over real objects in the display by the display module 218. In an embodiment of the present disclosure, the image capturing module 206 and the feedback module 226 may/may not be on a single glass frame. Further, the database 202 may store the gestures of the hands 106, the one or more control commands, the plurality of pre-defined actions and the feedback.

In an embodiment, the computing device 104 is associated with an application server, which may be remotely located. The application server may execute overall functioning of the computing device 104. In addition, the application server may maintain a centralized database to store the images of the gestures of the hands 106, the one or more commands, the pre-defined actions, and the feedback associated with the user 102.

Further, the computing device 104 may be connected to a network such as, the Internet® and can send/receive information from anywhere. For example, a device having the internet connection is used to send/receive information about anything at/from anywhere in the world.

In an embodiment of the present disclosure, it is contemplated that any suitable number of cameras or other image capturing modules can be used, such as two cameras of the computing device 104. The hands 106 of the user 102 can be covered with gloves. The feedback can be in any form including visual, tactile, audio, video, and the like.

In another embodiment of the present disclosure, since number of commands with simple gestures is limited, the user 102 can increase the number of commands by using sequence of simple gestures by defining macros. The sequence of simple gestures includes several recognized commands within a specified time interval.

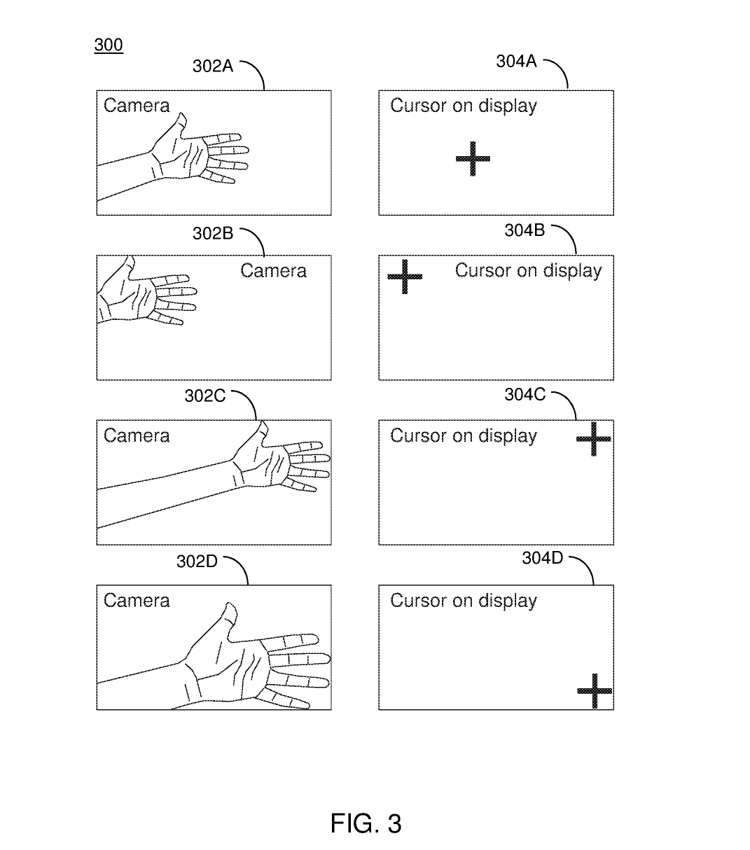

FIG. 3 illustrates an example of a use case 300 of a system for controlling a computing device using one or more gestures, in accordance with an embodiment of the present disclosure. As discussed with reference to the FIGS. 1-2, the use case 300 uses the computing device 104 (or 200) having a see through display. The use case 300 depicts resolution of the image of the gestures of the hands 106 captured by the image capturing module 206. The detection and resolution of the hands 106 differs on changing the distance between the hands 106 and the image capturing module 206 of the interactive computing device 104. Examples of the image capturing module 206 may include, but are not limited to, a camera, an infrared camera, scanning range detector devices (For example, LiDAR device) that provides a depth map of the image or environment. In an embodiment, the image capturing module 206 includes one or more sensors, such as the sensors 110, configured to capture spatial data and produce a two dimensional or three dimensional data map of the environment. This data map may then be analyzed or processed further by the analyzing module 210 or other modules as discussed with reference to FIG. 2.

In an embodiment of the present disclosure, the size of the hands 106 is bigger and the resolution of the image is lower when the hands 106 are closer to the image capturing module 206 of the interactive computing device 104 as shown in a camera view 302B and a camera view 302D. In another embodiment of the present disclosure, the size of the hands 106 is smaller and the resolution of the image is greater when the hands 106 are a little far away from the image capturing module 206 of the interactive computing device 104 as shown in a camera view 302A and a camera view 302C. This is similar to the mouse sensitivity with computers, when a hand is close, moving it one centimeter results in larger pointer move compared to when the hand is far. The camera views 302A-302D may be referred as user interfaces 302A-302D.

Further, the use case 300 uses relative coordinate mapping and computes coordinates of focus of the image of the hands 106. In an embodiment of the present disclosure, center of the hands 106 and relative size of the hands 106 determines position of cursor of the interactive computing device 104 as shown in displays 304A-304D.

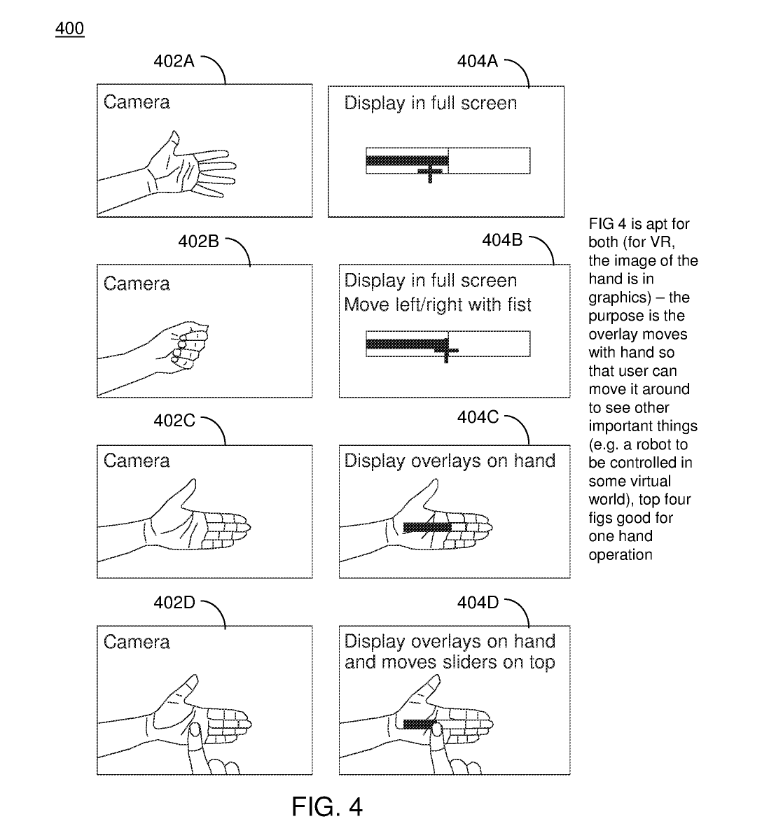

FIG. 4 illustrates another example of a use case 400 of a system for controlling a computing device using one or more gestures, in accordance with an embodiment of the present disclosure. The use case 400 defines a pre-determined mode switching start gesture for switching from a first user interface to a second user interface on a display of the computing device 102. The display may be a transparent (for example, Google Glass™) or a non-transparent display (For example, Oculus Rift). Further, both hands 106 may be used to switch mode or interface of the computing device 104. In an embodiment of the present disclosure, a hand of the hands 106 may be used a platform and other hand or a finger of the hands 106 may be used as a pointer for pointing objects on the platform. For example, when right hand of the user 102 acts as the platform, any finger of the left hand may act as the pointer as shown in a camera view 402D.

Further, in an embodiment, the modes may include a full screen mode and a partial screen mode. In the full screen mode, the user interface/computer graphics overlay 114 is displayed on the full screen of the display and in the partial screen modem the interface/computer graphics overlay 114 may be displayed at a partial screen of the display. Further, the overlay 114 moves with the movement of the hands 106. In an embodiment of the present disclosure, the open palm with fingers (as shown in a camera view 402C) close to each other is the pre-determined mode switching start gesture for defining the first user interface as shown by a user interface 404C. The first user interface 404A is an overlaid mode. In the overlaid mode, an operable space (for example, a slider) is overlaid on the palm. The operable space is an angle view of the image capturing module 206 of the interactive computing device 104.

In another embodiment of the present disclosure, the open palm with fingers separated from each other is the pre-determined mode switching start gesture for defining the second user interface as shown in the user interface 404A. The second user interface 404C is a full screen mode. In the full screen mode, the operable space is large. Further, in the full screen mode, a controllable element is visualized and moving the cursor increases/diminishes a value. For example, the controllable element is visualized in static position in a corner of a display and if the user X moves his fingers or palms (the cursor) left or down, the value (say volume) diminishes. Similarly, if the user X moves his fingers or palms (the cursor) right or up, the value (say volume) increases.

In an embodiment of the present disclosure, user interfaces 404A-404B of the FIG. 4 shows the full screen mode. The gesture is closing the hands 106 from the open palm to form the fist. In the full screen mode, when the cursor is over the slider, the slider is grabbed and modified. The opening of the hands 106 again as shown in the view 402C will set the slider as shown in the user interface 404C.

In an embodiment of the present disclosure, the user interfaces 404C-404D shows an overlay of the slider on the hands 106. Further, the user 102 receives a tactile feedback as the user 102 touches his hands 106. In an embodiment, the slider behaves as a touch screen slider. The value of the slider is set when the user 102 puts a pointing finger over the hands 106 and moves it.

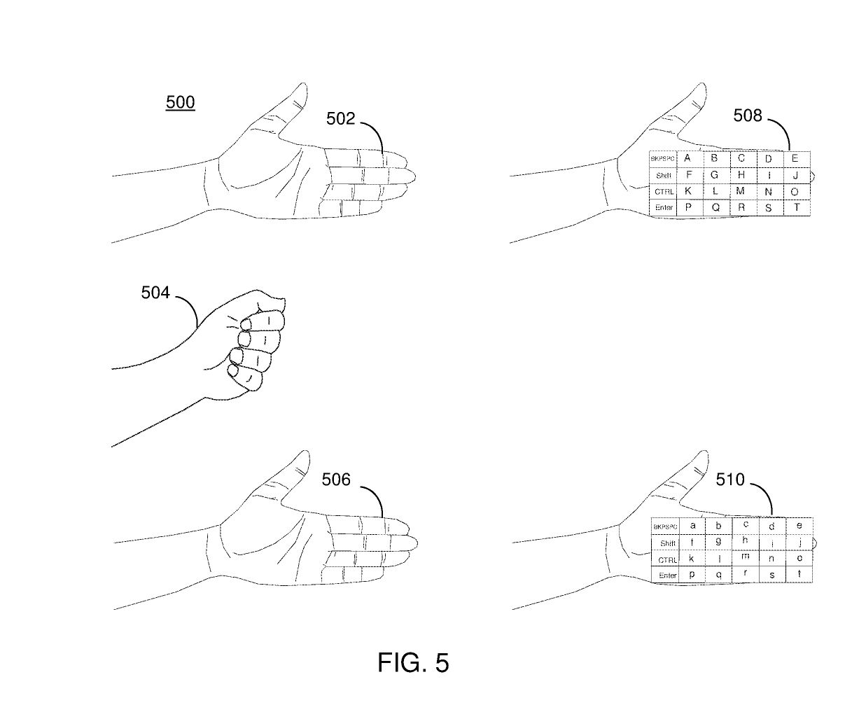

FIG. 5 illustrates an example of a use case 500 of a system using a toggling gesture using one or both of the hands 106 for changing one or more modes, in accordance with an embodiment of the present disclosure. The use case 500 defines one or more pre-determined hand gestures for corresponding one or more toggling modes. The one or more toggling modes include a keyboard layout (alphanumerical or numerical), an uppercase keyboard mode, a lowercase keyboard mode and the like. A user interface 508 shows the uppercase keyboard mode. A user interface 510 shows the lowercase keyboard mode. Further, the user 102 may change or switch among different modes of operation by toggling among one or more hand gestures on the user interface. Examples of the modes may include, but are not limited to, a lower case keyboard mode, an uppercase keyboard mode, a symbol based keyboard mode, a video mode, an audio mode, and so forth. In an embodiment, the mode includes a single hand operation mode for controlling the electronic devices 108A-108N or the computing device 104. In the alternative embodiment, the mode is a double hands mode for controlling the electronic devices 108A-108N or the computing device 104 via the two hands.

The use case 500 describes a first mode as shown by gestures 502, 504, 506, and a second mode as shown in the user interfaces 508-510. The first mode is the open palm of the hands 106 showing a viewport. The second mode is the overlay mode on top of the open palm. The one or more pre-determined start hand gestures may include an open palm, a fist, curled finger, and the like.

The pre-determined preamble hand gesture for selecting the first mode using a gesture 502 including open palm orthogonal to viewing direction with fingers spread. The pre-determined hand gesture for selecting the second mode (i.e. the user interface 508) is the open palm orthogonal to the viewing direction with the fingers not spread. The pre-determined hand gesture for the second mode may be used to direct the interactive computing device 104 to open the uppercase keyboard mode. A first i.e. the gesture 504 may be used to direct the interactive computing device 104 to remove the uppercase keyboard mode. Further, the gesture 506 i.e., opening the palm again may direct the interactive computing device 104 to open the lowercase keyboard mode. It is noted that when mode switching occurs, it is visualized immediately on displays.

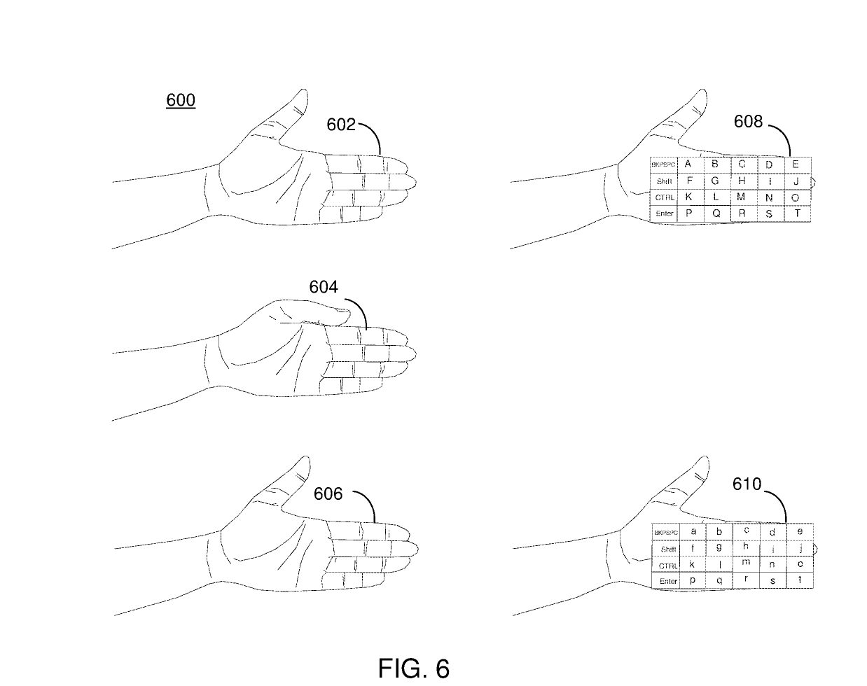

FIG. 6 illustrates yet another example of a use case 600 of a system using another toggling gesture for switching among the one or more modes, in accordance with an embodiment of the present disclosure. The use case 600 defines one or more pre-determined hand gestures for switching one or more toggling modes. The gestures for switching the one or more toggling modes may be referred as toggle gestures and may toggle in one or more dimensions. A user interface may be displayed on the computer graphics overlay 114 through a display mode by utilizing a pre-determined hand gesture or a start gesture.

The one or more toggling modes include a keyboard layout (alphanumerical or numerical), an uppercase keyboard mode, a lowercase keyboard mode, and the like. A user interface 608 shows the uppercase keyboard mode. A user interface 610 shows the lowercase keyboard mode.

The use case 600 describes a first mode in the user interface 608, and a second mode in the user interface 610. In an embodiment of the present disclosure, the display mode is a fixed position within a viewport (i.e., the first mode) and overlay mode on top of the palm (i.e., the second mode). The pre-determined start gesture for selecting the first mode may be an open palm orthogonal to a view direction with fingers spread. In an alternative embodiment of the present disclosure, the pre-determined start gesture for selecting the second mode is open palm orthogonal to viewing direction with fingers not spread.

In an embodiment of the present disclosure, the user interface is a variant of a physical user interface device including keyboard having alternate appearances including uppercase mode, lowercase mode, numerical mode, different language modes and the like. In another embodiment of the present disclosure, the user interface is a variant of a physical user interface device including television having alternative control modes including sound volume up/down, channel selection and the like.

The first mode is an open palm gesture 602 of the hands 106 showing a viewport or a viewing area. The second mode is the overlay mode on top of the open palm. The one or more pre-determined start hand gestures may include an open palm, an open palm with a thumb spread upside, curled finger, and the like.

The pre-determined start hand gesture for selecting the first mode using the open palm gesture 602 including an open palm orthogonal to viewing direction with fingers spread. The pre-determined hand gesture for selecting the second mode (i.e. the user interface 610) is the open palm orthogonal to the viewing direction with the fingers not spread. The pre-determined hand gesture for the second mode may be used to direct the interactive computing device 104 to open the uppercase keyboard mode. An open palm with a thumb spread upside, i.e. a gesture 604 may be used to direct the interactive computing device 104 to remove the uppercase keyboard mode. Further, a gesture 606 i.e., bringing the thumb back to down position may direct the interactive computing device 104 to open the lowercase keyboard mode (second mode). It is noted that when mode switching occurs, it is visualized immediately on displays. Though the FIGS. 5-6 shows gestures for changing keyboard related modes only, but a person ordinarily skilled in the art will appreciate that the user 102 may define the gestures to toggle between other modes of operations too.

In emulating commonly used user interface mechanisms, such as keyboard, there is different modes can be toggled through on or more toggle gestures. In a keyboard, such modes are keyboard layout (alphanumerical or numerical), uppercase/lowercase, and so on.

Examples of the toggle gesture may include, such as, but not limiting to, an open palm, making a fist, opening palm, moving palm upside down, waving hand, bringing hand close to the display, and so forth. When mode switching occurs, it is visualized in immediately on the display. The toggle gestures may cause the display to switch between the one or more control options or interfaces in a round-robin way.

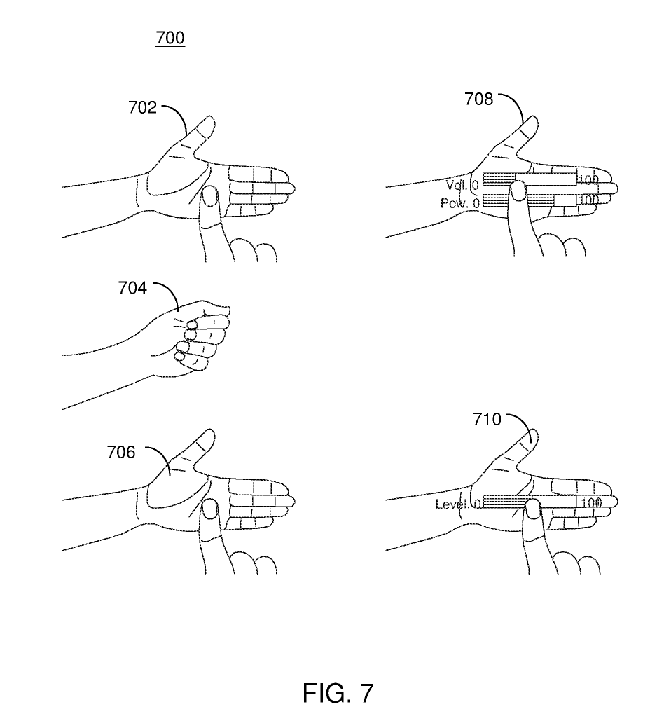

FIG. 7 illustrates a yet another example of a use case 700 of using a system for controlling a computing device using one or more gestures, in accordance with another embodiment of the present disclosure. The use case 700 explains toggling between several controllable objects or actions or modes of operation with the same gesture. Further, the user 102 may change or toggle one or more modes of operations of the computing device 104 via the pre-defined gestures. For example, an open palm gesture 702 may be used to alter the volume, turning on/off power switch and the like as shown in a user interface 708. In some embodiments, the toggling of gestures, i.e. the gestures 702-706, causes the displays to switch between control options in a round-robin way. A closed first gesture 704 may be used to close the user interface, and again an open palm gesture 706 may be used to increase a level as shown by a user interface 710.

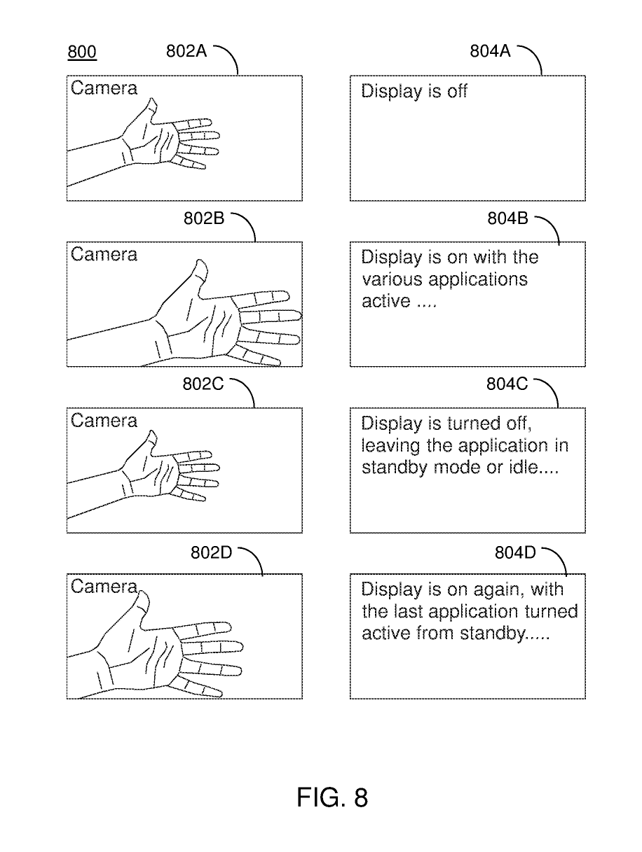

FIG. 8 illustrates another example of a use case 800 of using a system for controlling a computing device using one or more gestures, in accordance with another embodiment of the present disclosure. The use case 800 provides gestures for turning on/off the display of the interactive computing device 104. The display is turned on and off regularly to enable the user 102 to clearly see objects in surroundings. The display is off when an open palm is away from the display as shown by a gesture 802A and in a user interface 804A. The display module 218 controls the turning off and turning on of the display based on the start and the end gesture. In augmented reality glasses, turning off of the display quickly and turn it on back again, may enable the user 102 to see the surrounding world clearly.

In an embodiment of the present disclosure, the display can be turned on by moving the open palm close to the display as shown by a gesture 802B and in a user interface 804B. In another embodiment of the present disclosure, the display can be turned off by moving the open palm away from the display as shown by a gesture 802C and in a user interface 804C. In yet another embodiment of the present disclosure, moving the open palm towards right side may indicate that the display is turned on with various applications in active mode as shown by a gesture 802D and in a user interface 804D. In yet another embodiment of the present disclosure, moving the open palm with spacing between the fingers away from the display may indicate that the display is turned off with the various applications in standby mode. In yet another embodiment of the present disclosure, moving the open palm with spacing between the fingers close to the display may indicate that the display is turned on with last application turned active from the standby mode.

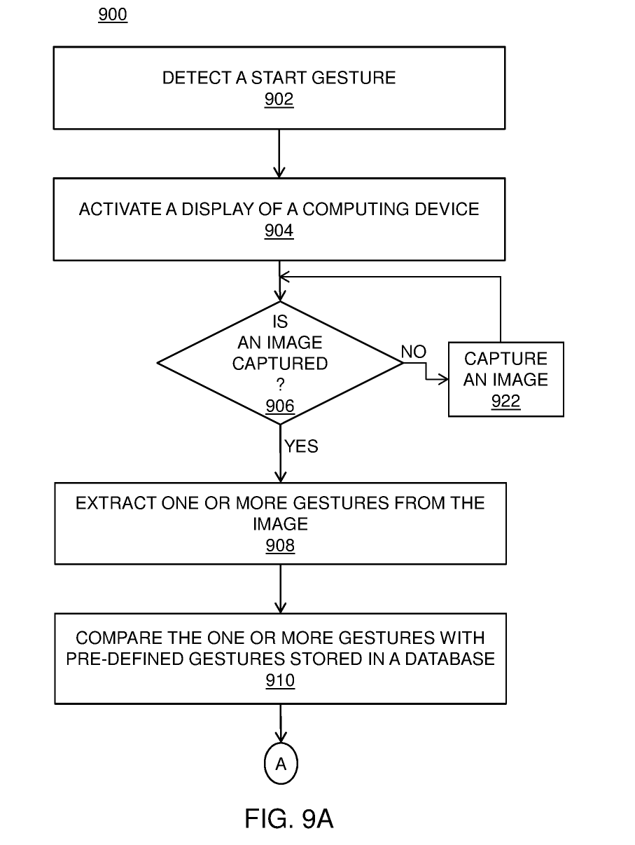

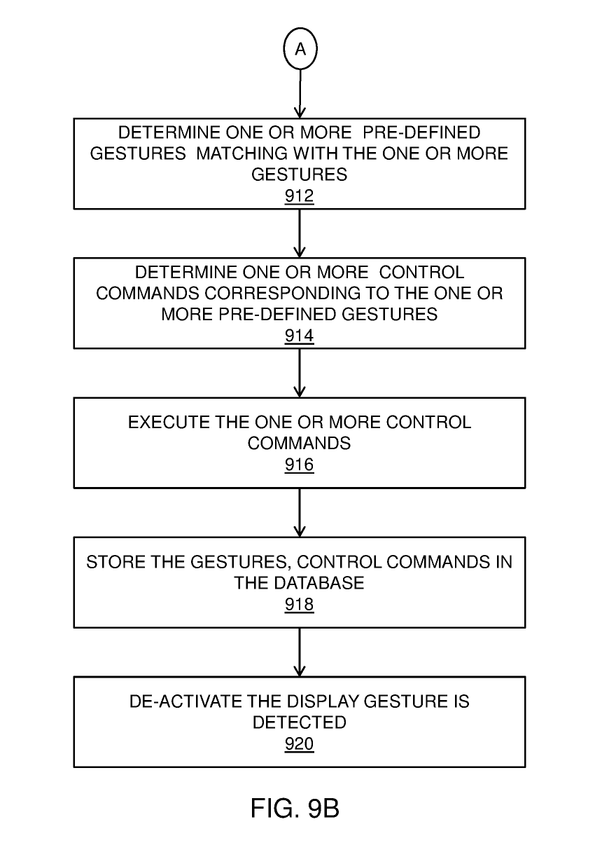

FIGS. 9A-9B is a flowchart illustrating a method 900 for controlling a computing device with a number of hand gestures, in accordance with an embodiment of the present disclosure. As discussed with reference to FIG. 1, the user 102 can control one or more settings or functions of the computing device 104 or/and the electronic devices 108A-108N by providing one or more gestures or hand gestures using the hands 106. The computing device 104 (or computing device 200) can be a wearable computing device. As discussed with reference to the FIG. 2, the computing device 104 (or 200) includes multiple modules.

At step 902, a start gesture is detected. In an embodiment, the detection module 204 detects the start gesture. The detection module 204 can detect any gesture only when the gesture is performed in a viewing area or a user interface which is viewable via the detection module 204. Further, the detection module 204 and the image capturing module 206 continuously keeps on detecting and capturing images, respectively. The start gesture may be a hand gesture including opening a fist, an open palm, a closed first with at least one of finger or thumb in open or up position, waving hand, and so forth. At step 904, a display associated with the computing device 200 is activated. Then at step 906, it is checked whether an image is captured. If yes then step 908 is executed else control goes to step 922. At step 922, an image is captured. In an embodiment, the image capturing module 206 such as a camera captures the one or more images. The one or more images include a number of images including one or more gestures.

At step 908, the one or more gestures are extracted from the image. In one embodiment, the analyzing module 210 extracts the one or more gestures from the image. Further, the images are captured simultaneously and the analyzing module 210 may analyze the images in real-time. Then at step 910, the one or more gestures are compared with pre-defined gestures stored in the database 202. The analyzing module 210 may compare the one or more gestures with the pre-defined gestures. At step 912, one or more pre-defined gestures matching the one or more gestures are determined. The analyzing module 210 may determine the one or more pre-defined gestures matching the one or more gestures. The analyzing module 210 may use one or more algorithms for detecting gesture. The one or more algorithms may include at least one of an adaptive real-time skin detector algorithm based on hue thresholding, algorithms based on the color of the hand and algorithms based on pattern recognition including 3D object recognition.

Thereafter at step 914, one or more control commands corresponding to the one or more pre-defined gestures are determined. In some embodiments, the analyzing module 210 determines the one or more pre-defined control commands. Then at step 916, the one or more control commands are executed. In one embodiment, the one or more settings of at least one of the electronic devices 108A-108N is controlled based on the one or more control commands. In an alternative embodiment, one or more settings of the computing device 104 based on the one or more control commands.

At step 918, the gestures, control commands, and so forth are stored in the database 202. Thereafter at step 920, the display is de-activated when an end gesture is detected. In some embodiments, the detection module 204 detects the end gesture. The end gesture may include a closed palm gesture, a thumb down gesture, a first gesture, and the like. In some embodiments of the present disclosure, the gestures facilitate de-activation of the computer graphics overlay 114 by moving the hand away or from one side to the other of the image capturing module 206.

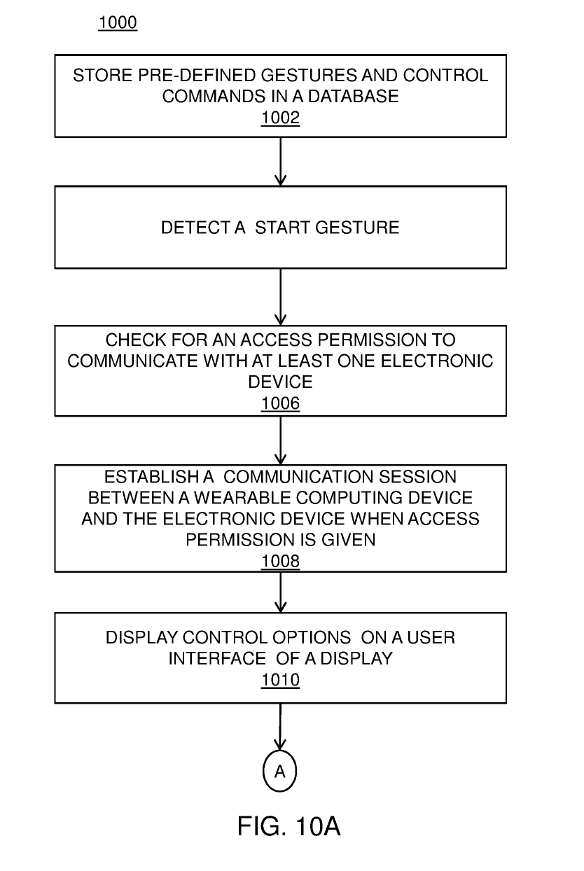

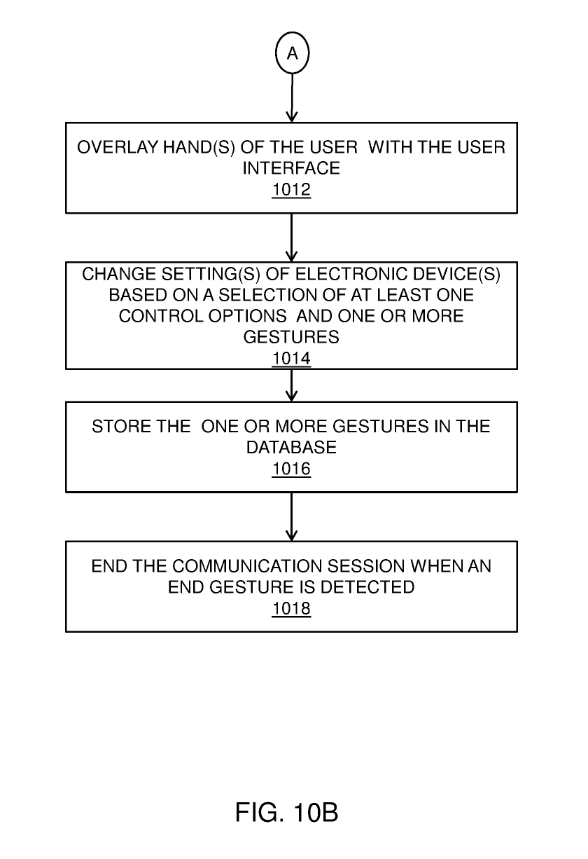

FIGS. 10A-10B is a flowchart illustrating a method 1000 for controlling a computing device with a number of hand gestures, in accordance with another embodiment of the present disclosure. As discussed with reference to FIG. 1, the user 102 can control one or more settings or functions of the electronic devices 108A-108N by providing one or more gestures or hand gestures using the hands 106. The computing device 104 (or computing device 200) can be a wearable computing device. As discussed with reference to the FIG. 2, the computing device 104 (or 200) includes multiple modules.

At step 1002, pre-defined gestures and control commands are stored. In one embodiment, the pre-defined gestures and control commands are stored in the database. In an alternate embodiment, the pre-defined gestures and control commands are stored in a remote database located on another computing device or server. At step 1004, a start gesture including an open palm gesture is detected. In some embodiments, the detection module 204 detects the start gesture. The start gesture can be a hand gesture including opening a fist, a closed first with at least one of finger or thumb in open or up position, waving hand, and so forth. On detection of the start gesture, a display of the computing device 200 (or 104) is activated. The image capturing module 206 may continuously capture the images and is never turned off. Similarly, the detection module 204 may continuously detect a number of gestures.

Then at step 1006, a check is performed for checking access permission for communicating with at least one of the electronic devices 108A-108N. The access managing module 214 may check for the access permission. At step 1008, a communication session is established between the computing device 104 (or 200) and the at least one of the electronic devices 108A-108N. At step 1010, one or more control options are displayed at a user interface of a display. In some embodiments, the display module 218 displays the control options on the user interface of the display. The user interface may include the computer graphics overlay 114. The display may be an opaque screen, which is not a see-through display, or a transparent screen. In one embodiment, the display is see-through and the interface may be overlapped over real objects in the display by the display module 218.

At step 1012, the one or more hands 106 of the user 102 are overlaid with the user interface to allow the user 102 to control the at least one of the computing device 104 and the electronic devices 108A-108N. The controlling module 212 may overlay the hands 106 of the user with the user interface. Then at step 1014, one or more settings of the at least one of the electronic devices 108A-108N or the computing device 104 are changed based on a selection of at least one of the control options by the user 102 and one or more gestures of the user 102. The Input/Output module 220 may receive the selection of the at least one of the control options from the user 102. In one embodiment, the detection module 204 detects the one or more gestures of the user 102 that are performed on the user interface.

Then at step 1016, the one or more gestures are stored in the database 202. Thereafter at step 1018, the communication session is ended when an end gesture is detected. The detection module 204 may detect the end gesture and the session managing module 216 may end the communication session.

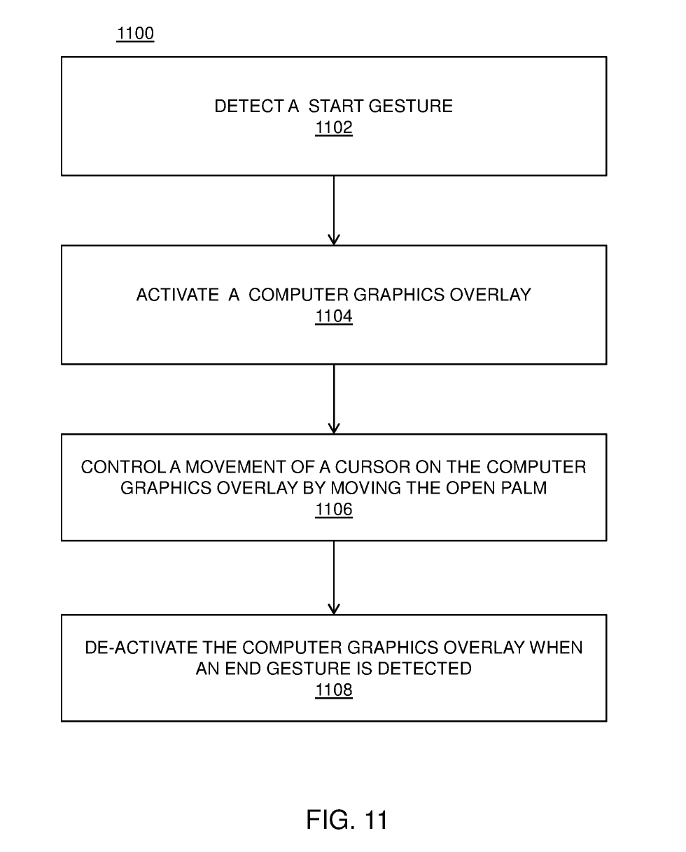

FIG. 11 is a flowchart illustrating an exemplary method 1100 for controlling movement of a cursor using hand gestures on the computer graphics overlay 114, in accordance with an embodiment of the present disclosure. At step 1102, a start gesture including such as, but not limited to, an open palm gesture is detected. At step 1104, the computer graphics overlay 114 is activated. In an embodiment, the display module 218 activates the computer graphics overlay at a display as discussed with reference to FIG. 2. In some embodiments, the gestures enable activation of the computer graphics overlay 114 by moving the open palm towards the image capturing module 206. The display may be an opaque screen, which is not a see-through display, or a transparent screen. In one embodiment, the display is a see-through display and the user interface may be overlapped over real objects in the display by the display module 218. Further, the display may be a wearable display or a non-wearable display associated with the computing device 104.

At step 1106, a movement of a cursor is controlled on the computer graphics overlay 114 by moving the open palm. In some embodiments of the present disclosure, the controlling module 212 controls the movement of the cursor based on one or more hand gestures of the user 102. In one embodiment, movement of the hands 106 of the user 102 is mapped onto the computer graphics overlay 114 and is represented as the cursor. In some embodiments of the present disclosure, the cursor movement is controlled by moving an open palm within a viewport of the image capturing module 206. In some embodiments of the present disclosure, a cursor position displayed on the computer graphics overlay 114 is calculated as a function of hand size and position. The display may be an opaque screen which is not a see-through display (for example, a video see-through display), or a transparent screen. In one embodiment, the display is see-through and the interface may be overlapped over real objects in the display by the display module 218. In an embodiment of the present disclosure, cursor appearance on the computer graphics overlay 114 is altered if the open palm is not recognized.

Thereafter at step 1108, the computer graphics overlay 114 is de-activated when an end gesture is detected. The end gesture may include a fist, a closed palm, a thumb down, closing one or more fingers of the hands 106. In some embodiments of the present disclosure, the gestures facilitate de-activation of the computer graphics overlay 114 by moving the hand away or from one side to the other of the image capturing module 206.

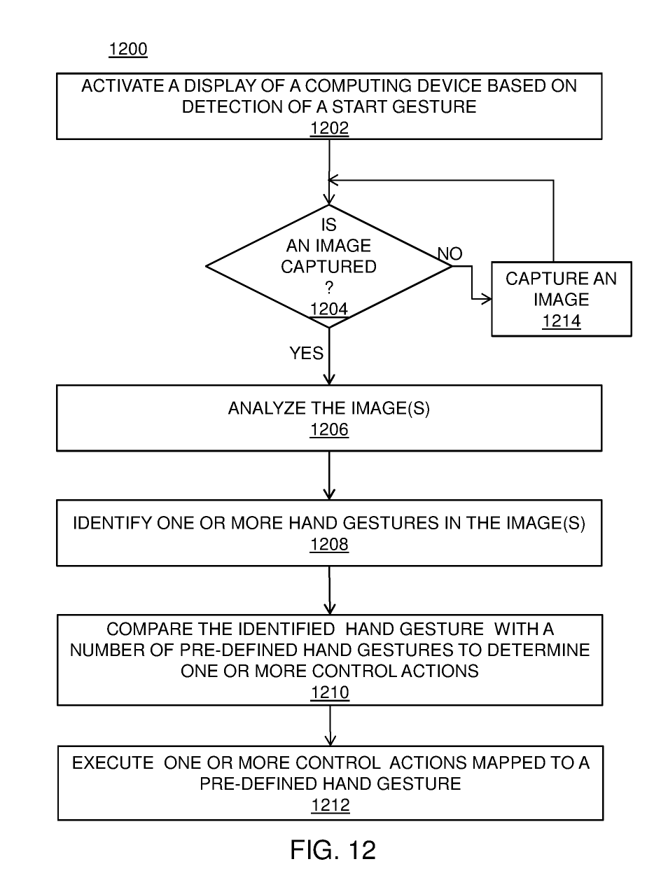

FIG. 12 is a flowchart illustrating an exemplary method 1200 for controlling an electronic device by mapping one or more actions based on gestures, in accordance with an embodiment of the present disclosure. At step 1202, a display of the computing device 104 is activated when a start gesture is detected. At step 1204, it is checked whether an image is captured. If yes then step 1206 is followed else step 1214 is executed. At step 1212, an image is captured. In an embodiment, more than one image is captured. The image capturing module 206 may capture the image or a sequence of images including multiple images of the gestures, primarily hand gestures. At step 1206, the image(s) is analyzed. Then at step 1208, one or more hand gestures are identified in the image(s). At step 1210, the identified hand gesture is compared with a number of pre-defined gestures to determine one or more control actions. In an embodiment, the CPU 224 analyzes the sequence of images to identify the hand gesture by comparing. At step 1212, an action mapped onto a pre-defined hand gesture is executed. The pre-defined hand gesture is a matching gesture corresponding to the hand gesture of the sequence of images. In some embodiments, the CPU 224 determines the pre-defined hand gesture and associated action from the database 202 or the memory 222.

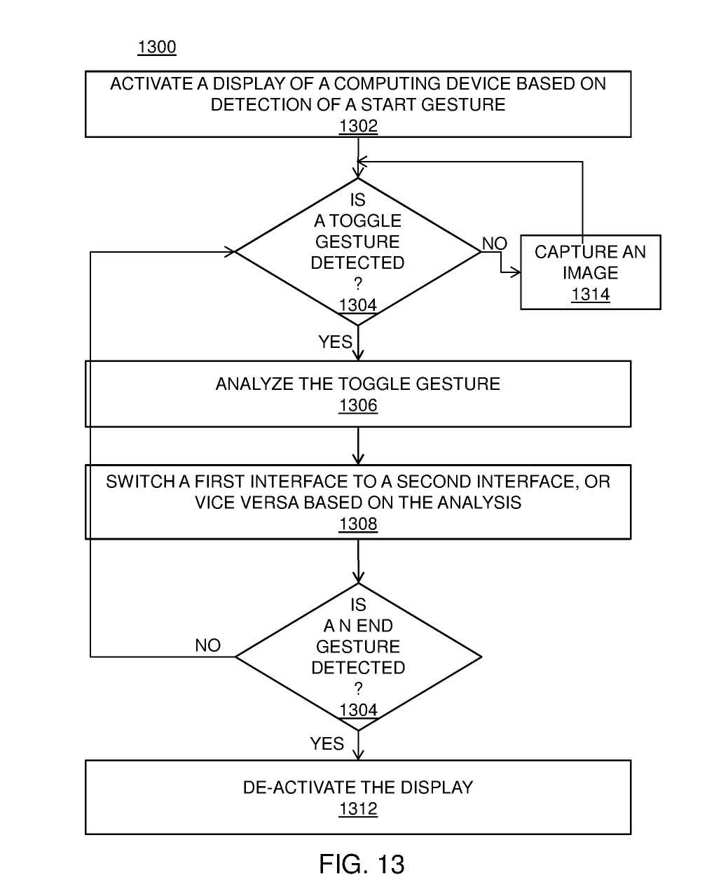

FIG. 13 is a flowchart illustrating an exemplary method 1300 for controlling computing device 104 based on one or more toggle gestures, in accordance with an embodiment of the present disclosure. At step 1302, a display of the computing device 104 is activated when a start gesture is detected. At step 1304, it is checked whether a toggle gesture is detected or not. In an embodiment, the detection module 204 detects the toggle gesture in an image captured by the image capturing module 206. If yes then step 1306 is executed else step 1314 is executed. At step 1314, an image or one or more image is captured.

At step 1306, the toggle gesture is analyzed to identify one or more control commands. The analyzing module 210 is configured to analyze the toggle gesture. The analyzing module 210 is also configured to compare the detected toggle gesture with the pre-defined gestures stored in the database 202. The pre-defined gestures may be defined by the user.

At step 1308, a first interface on the display of the computing device 104 is switched to a second interface on the display, or vice versa, based on the analysis of the toggle gesture. In some embodiments, the controlling module 212 is configured to switch a first interface of the computing device 104 to a second interface based on the analysis. The first interface may be based on a mode of operation. In an exemplary scenario, the first interface is a lowercase keyboard interface, and the second interface is an uppercase keyboard. Examples of the mode of operation may be like, but not limiting to, a lowercase keyboard mode, an uppercase keyboard mode, a volume control mode, a channel control mode, and so forth. In some embodiments, the first interface and the second interface are displayed on the computer graphics overlay 114.

At step 1310, it is checked whether an end gesture is detected or not. If yes, then step 1312 is executed else control goes back to step 1304. At step 1312, the display is de-activated when an end gesture is detected. The end gesture may include, such as, but not limited to, a closing of the palm, a thumb down, and so forth. It may be noted that the flowcharts in FIGS. 9A-9B, 10A-10B, 11, and FIG. 12 are explained to have above stated process steps; however, those skilled in the art would appreciate that the flowcharts may have more/less number of process steps which may enable all the above stated embodiments of the present disclosure.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A method for controlling a computing device through a plurality of hand gestures, the method comprising:
detecting a toggle gesture;
analyzing the toggle gesture; and
switching a first interface of the computing device to a second interface based on the analysis of the toggle gesture.

2. The method of claim 1 further comprising comparing the toggle gesture with a plurality of pre-defined gestures.

3. The method of claim 1 further comprising activating a display associated with the computing device based on a detection of a start gesture.

4. The method of claim 1 further comprising de-activating the display associated with the computing device based on a detection of an end gesture.

5. The method of claim 2, wherein the pre-defined gestures are defined by a user.

6. A system for controlling a computing device through a plurality of hand gestures, the system comprising:
a database configured to store a plurality of pre-defined gestures, a plurality of pre-defined actions, a plurality of modes of operation, a toggle gesture, a start gesture, an end gesture, and a plurality of pre-defined control commands;
a detection module configured to detect a toggle gesture;
an analyzing module configured to:
analyze the detected toggle gesture; and
compare the detected toggle gesture with the plurality of pre-defined gestures; and
a controlling module configured to switch a first interface of the computing device to a second interface based on the analysis.

7. The system of claim 6, wherein the detection module is configured to detect a start gesture and an end gesture.

8. The system of claim 6, wherein the display module is configured to:
activate a display of the computing device when the start gesture is detected; and
de-activate the display of the computing device when the end gesture is detected.

9. The system of claim 6, wherein the first interface and the second interface are displayed on a computer graphics overlay.

10. A method for controlling a computing device through a plurality of hand gestures, the method comprising:
detecting a toggle gesture;
activating a display of the computing device based on the detection of the toggle gesture;
displaying a computer graphics overlay on the display, wherein a hand of a user is mapped onto the computer graphics overlay; and
controlling a movement of a cursor on the computer graphics overlay based on one or more hand gestures of the user.

11. The method of claim 10 further comprising:
capturing spatial data based on a movement of the hand in a viewable area of the computing device;
producing at least one of a two dimensional and a three dimensional data map;
determining a pre-defined action corresponding to the at least one of the two dimensional and the three dimensional data map; and
executing the pre-defined action.

12. The method of claim 10, further comprising:
determining one or more pre-defined hand gestures based on the one or more hand gestures;
determining one or more pre-defined control commands corresponding to the one or more pre-defined hand gestures; and
executing the one or more pre-defined control commands.

13. The method of claim 12, wherein a cursor position displayed on the computer graphics overlay is calculated as a function of a size of the hand and a position of at least one of the hand and fingers of another hand.

14. The method of claim 10, de-activating the display of the computing device when an end gesture is detected.

15. A system for controlling a computing device through a plurality of hand gestures, the system comprising:
a detection module for detecting a toggle gesture;
a display module configured to:
activate a display of the computing device based on the detection of the toggle gesture; and
display a computer graphics overlay on the display, wherein a hand of a user is mapped onto the computer graphics overlay; and
a controlling module configured to control a movement of a cursor on the computer graphics overlay based on one or more hand gestures of the user.

16. The system of claim 15, further comprising an image capturing module comprising one or more sensors configured to capture spatial data based on a movement of the hand in a viewable area of the computing device.

17. The system of claim 15, further comprising an analyzing module configured to:
produce at least one of a two dimensional and/or a three dimensional data map; and
determine at least one pre-defined action corresponding to the at least one of the two dimensional and/or the three dimensional data map, wherein the controlling module is configured to execute the at least one pre-defined action.

18. The system of claim 17, wherein the analyzing module is further configured to:
determine one or more pre-defined hand gestures based on the detected hand gestures; and
determine one or more pre-defined control commands corresponding to the one or more pre-defined hand gestures, wherein the controlling module is configured to execute the one or more pre-defined control commands.

19. The system of claim 15, wherein the controlling module is configured to calculate a cursor position displayed on the computer graphics overlay as a function of a size of the hand and a position of at least one of the hand and finger of another hand.

20. The system of claim 15, wherein the display module is configured to de-activate the display of the computing device when an end gesture is detected.

21. The system of claim 15, wherein the display is selected from a group consisting of a transparent display, a non-transparent display, and a wearable display.

22. A method for controlling a computing device through a plurality of hand gestures, the method comprising:
detecting a start gesture;
activating a display of the computing device based on the detection of the start gesture;
detecting a toggle gesture;
analyzing the toggle gesture;
switching a first interface of the computing device to a second interface based on the analysis of the toggle gesture; and
de-activating the display when an end gesture is detected.
